(19) United States
(12) Patent Application Publication
(10) Pub. No.: US 2023/0199747 A1
(43) Pub. Date: Jun. 22, 2023

(54) CONTROL SYSTEM, CONTROL METHOD, CONTROLLER, AND PROGRAM

(71) Applicant: NIPPON TELEGRAPH AND TELEPHONE CORPORATION, Tokyo (JP)

(72) Inventors: Yuki SAKAUE, Musashino-shi, Tokyo (JP); Katsuya MINAMI, Musashino-shi, Tokyo (JP); Tatsuya FUKUI, Musashino-shi, Tokyo (JP)

(73) Assignee: NIPPON TELEGRAPH AND TELEPHONE CORPORATION, Tokyo (JP)

(21) Appl. No.: 17/913,131

(22) PCT Filed: Apr. 27, 2020
(86) PCT No.: PCT/JP2020/018029

§ 371 Date: Sep. 20, 2022

(30) Foreign Application Priority Data
Mar. 24, 2020 (WO) PCT/JP2020/012871

(51) Int. Cl. H04W 72/12; H04W 28/14

(52) U.S. Cl. CPC H04W 72/12; H04W 28/14

(57) ABSTRACT

It is an object to the present invention to provide a control system, a control method, a controller, and a program which allow a band allocated to each of traffic flows to be guaranteed.

According to the present invention, terminals and an access point each store packets to be transmitted to buffers therein on a traffic flow basis and notify the controller of the amount of stored packets, the controller determines transmission time and a transmission amount of packets on a traffic flow basis according to the notified packet amount to notify a corresponding terminal and the access point of the time and amount, and the terminal and the access point transmit packets according to the notified transmission time and transmission amount.

### TECHNICAL FIELD

The present disclosure relates to a control system, a control method, a controller, and a program for allocating a communication band in an access network.

### BACKGROUND ART

In recent years, studies have been underway to accommodate multiple services and applications with various network requirements in the same network infrastructure. To this end, the qualities requested by services or applications accommodated in the same network must be guaranteed in End-to-End sections such as a “terminal to terminal section” or a “terminal to application server section”.

End-to-End sections in a network can be divided into wireless and wired sections. Above all, the priority control function called Enhanced Distributed Channel Access (EDCA) of IEEE 802.11 is known as an existing technology for wireless sections (NPL 1 and NPL 2).

### CITATION LIST

### Non Patent Literature

[NPL 1] IEEE 802.11e-2005—IEEE Standard for Information technology—Local and metropolitan area networks—Specific requirements—Part 11: Wireless LAN Medium Access Control (MAC) and Physical Layer (PHY) Specifications—Amendment 8: Medium Access Control (MAC) Quality of Service Enhancements
[NPL 2] “IEEE 802.11e-QoS Enhanced Wireless LAN Standard”, The Journal of the Institute of Image Information and Television Engineers, Vol. 57, No. 11 (2003)

### SUMMARY OF THE INVENTION

### Technical Problem

However, the EDCA is control on a terminal (destination) basis, and control on a traffic flow basis which enables for example quality control on a service and application basis can be difficult. Therefore, in order to solve the problem, it is an object of the present invention to provide a control system, a control method, a controller, and a program which allow a band allocated to each traffic flow to be guaranteed.

### Means for Solving the Problem

In order to achieve the object, a control system according to the present invention includes a controller which allocates a transmission band on a traffic flow basis in response to a notification from a terminal.

Specifically, a control system according to the present invention controls traffic over a wireless network and includes a terminal and an access point which transmit a packet to each other over the wireless network and a controller which carries out transmission control to the terminal and the access point, and the controller determines a band control value for each traffic flow according to a required band for the traffic flow notified at least from the terminal and notifies the terminal and the access point of the band control value.

A control method according to the present invention controls traffic over a wireless network and is transmission control carried out by a controller to a terminal and an access point which transmit a packet to each other over the wireless network, and the method includes determining a band control value for each traffic flow according to a required band for the traffic flow notified at least from the terminal and notifying the terminal and the access point of the band control value.

A controller according to the present invention controls traffic over a wireless network and is a device which carries out transmission control to a terminal and an access point which transmit a packet to each other over the wireless network, the controller has the function of determining a band control value for each traffic flow according to a required band for the traffic flow notified at least from the terminal and notifying the terminal and the access point of the band control value.

The control system and other features according to the present invention allocate a transmission band for each traffic flow from a required band for the traffic flow notified to the controller, and therefore a band for each traffic flow can be guaranteed. Therefore, according to the present invention, a control system, a control method, and a controller which allow a band allocated to each traffic flow to be guaranteed can be provided.

According to a first control approach, the terminal and the access point in the control system according to the present invention each include a buffer which stores transmission packets on a traffic flow basis, a device side transmitting/receiving unit which transmits the amount of stored transmission packets on a traffic flow basis stored in the buffer and receives transmission time and a transmission amount of the transmission packets on a traffic flow basis from the controller as the band control value, and a main signal transmitting unit which transmits the transmission packets on a traffic flow basis in the buffer to the wireless network according to the transmission time and the transmission amount, and the controller includes a control side transmitting/receiving unit which receives the stored amount each from the terminal and the access point as the required band and transmits the transmission time and the transmission amount to each of the terminal and the access point as the band control value and a scheduling unit which determines the transmission time and the transmission amount of the transmission packets on a traffic flow basis according to the stored amount.

According to the approach, the transmission time and amount of packets are controlled on a traffic flow basis, so that a transmission band can be allocated on a traffic flow basis, and therefore a band for each traffic flow can be guaranteed.

According to a second approach, the terminal in the control system according to the present invention includes a terminal side transmitting/receiving unit which transmits a band requested by an application to the controller as the required band and receives the band control value from the controller when the terminal is connected to the controller and the application is added, and a terminal side band control unit which sets the band control value for each of the applications, the access point includes an access point side transmitting/receiving unit which receives the band control value from the controller and an access point side band control unit which sets the band control value for each of the applications, and the controller includes a control side transmitting/receiving unit which receives the required band from the terminal and transmits the band control value to each of the terminal and the access point, and a calculating unit which determines the band control value according to the sum total of the required bands.

According to the approach, the controller calculates a band control value for each traffic flow from a requested band and the terminal or the access point transmits packets according to the notified band control value and therefore a band for each traffic flow can be guaranteed.

The calculating unit according to the second control approach sets the required band for each of the traffic flows as the band control value when the sum total is less than the communication band of the wireless network, and the calculating unit sets, as the band control value, a value obtained by reducing the required band for each of the traffic flows so that the sum total is at most equal to the communication band when the sum total is at least equal to the communication band of the wireless network.

The controller calculates the band control value so that the total of required bands from the terminals and the access point does not exceed the communication band of the network and avoids congestion of the network.

The present invention concerns a program adapted to cause a computer to function as a controller. The controller can be implemented by a computer and a program, and the program can be recorded on a recording medium or provided over a network.

The features can be combined in any way possible.

### Effects of the Invention

According to the present invention, a control system, a control method, a controller, and a program which allow a band allocated to each traffic flow to be guaranteed can be provided.

### BRIEF DESCRIPTION OF DRAWINGS

FIG. 1 is a diagram for illustrating a control system according to the present invention.

FIG. 2 is a diagram for illustrating the control system according to the present invention.

FIG. 3 illustrates a database provided in the controller according to the present invention.

FIG. 4 is a flowchart for illustrating a control method according to the present invention.

FIG. 5 is a diagram for illustrating the effect of the control system according to the present invention.

FIG. 6 is a diagram for illustrating the operation of a communication system related to the present invention.

FIG. 7 is a diagram for illustrating a control system according to the present invention.

FIG. 8 illustrates a database provided in a controller according to the present invention.

FIG. 9 is a diagram for illustrating a control method according to the present invention.

FIG. 10 is a diagram for illustrating the effect of the control system according to the present invention.

FIG. 11 is a diagram for illustrating the control system according to the present invention.

### DESCRIPTION OF EMBODIMENTS

Embodiments of the present invention will be described in conjunction with the accompanying drawings. The following description is about embodiments of the present invention, and the present invention is not limited by the embodiments. Note that the elements designated by the same reference characters in the description and the drawings refer to the same elements.

(Basic Structure)

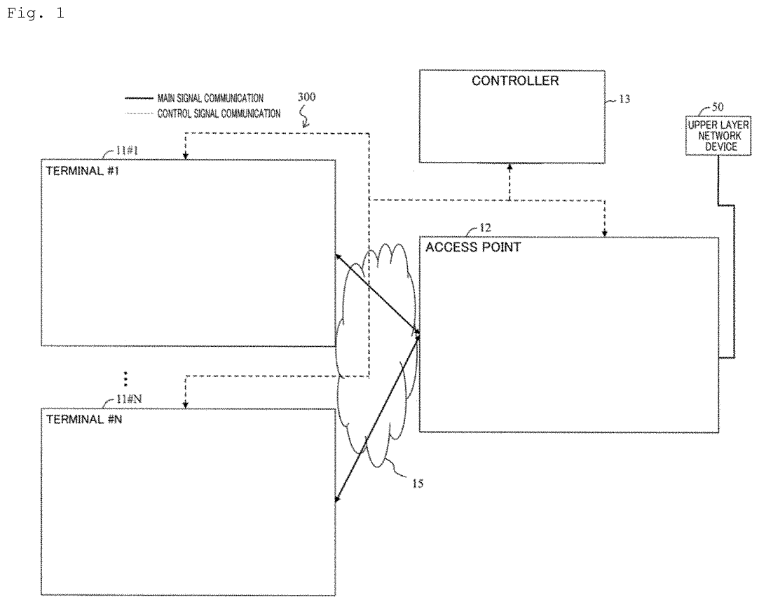

A basic structure of the control system according to the embodiment will be described. FIG. 1 is a diagram for illustrating the control system 300 according to the embodiment. The control system 300 controls traffic over a wireless network 15 and includes terminals 11 and an access point 12 which transmit packets to each other over the wireless network 15 and a controller 13 which carries out transmission control to the terminals 11 and the access point 12, and the controller 13 determines a band control value for each of traffic flows notified at least from terminal 11 on the basis of a required band for the traffic flow and notifies the terminal 11 and the access point 12 of the band control value.

Using the required band for each of the traffic flows notified to the controller from the terminal 11, the control system 300 calculates a transmission band for the traffic flow. Therefore, the control system 300 can guarantee a band for each of the traffic flows.

There are two approaches for band control on a traffic flow basis. These approaches will be described in detail in connection with first and second embodiments of the invention.

### Second Embodiment

The first band control approach according to the second embodiment will be described.

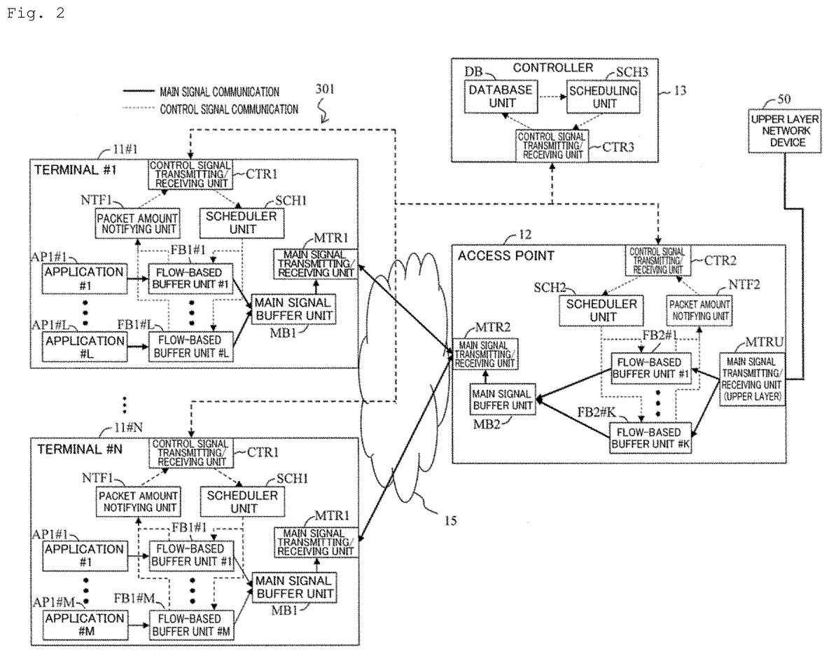

FIG. 2 is a diagram for illustrating the control system 301 according to the embodiment. The control system 301 connects terminals 11 and an access point 12 to a controller 13, and packets are stored in traffic flow-based buffers (FB1 and FB2) in the terminals 11 and the access point 12 or in buffers in applications, the controller 13 is notified of the amount of the stored packets in advance, transmission time and a transmission amount on a traffic basis are determined at the scheduling unit SCH3 of the controller 13, the transmission time and the transmission amount are notified to the terminals 11 and the access point 12 from the controller 13, and packets are transmitted according to the transmission time and the transmission amount notified to the terminals 11 and the access point 12.

Note that the terminals 11, the access point 12, and the controller 13 are synchronized in time for example using NTP or PTP.

Specifically, the control system 301 controls traffic over the wireless network 15 and includes the terminals 11 and the access point 12 which transmit packets to each other over the wireless network 15, the controller 13 which carries out transmission control to the terminals 11 and the access point 12, the terminals 11 and the access point 12 each include a buffer (FB1 or FB2) which stores transmission packets on a traffic flow basis, a device side transmitting/receiving unit (CTR 1 or CTR2) which transmits the amount of the traffic-flow based transmission packets stored in the buffer (FB1 or FB2) to the controller 13 and receives the transmission time and amount of the traffic flow-based transmission packets from the controller 13, and a main signal transmitting unit (MTR1 or MTR2) which transmits the traffic flow-based transmission packets in the buffer (FB1 or FB2) to the wireless network 15 according to the transmission time and amount, and the controller 13 includes a control side transmitting/receiving unit CTR3 which receives the stored amount each from the terminals 11 and the access point 12 and transmits the transmission time and amount to each of the terminals 11 and the access point 12 and a scheduling unit SCH3 which determines the transmission time and amount of the traffic flow-based transmission packets according to the stored amount.

The control system 301 communicates control signals between the controller 13 and the access point 12/the terminal 11 by communication means other than the communication means for main signals (packets in traffic). Specifically, the control signal is exchanged between the control signal transmitting/receiving unit CTR1 of the terminal 11 and the control signal transmitting/receiving unit CTR3 of the controller 13 and between the control signal transmitting/receiving unit CTR2 of the access point 12 and the control signal transmitting/receiving unit CTR3 of the controller 13.

The terminals 11 and the access point 12 regularly notify the controller 13 of the amount of packets stored in the flow-based buffer unit (FB1 or FB2) as a control signal.

The terminals 11 each store packets from each application AP1 in the buffer FB1 for each application (for each flow). A packet amount notifying unit NTF1 regularly checks the amount of packets stored in each buffer FB1 and notifies the controller 13 of the amount as a control signal through the control signal transmitting/receiving unit CTR1.

The access point 12 stores packets from an upper layer network device 50 in the buffer FB2 on an application (flow) basis. The packet amount notifying unit NTF2 regularly checks the amount of packets stored in each buffer FB2 and notifies the controller 13 of the amount as a control signal through the control signal transmitting/receiving unit CTR2.

Note that the application AP1 may have the flow-based buffer unit FB1.

The controller 13 records the notified stored amount of packets and information about terminals 11, the access point 12, and the flow-based buffers (FB1 and FB2), determines transmission time and amount for each buffer accordingly, and notifies the terminals 11 and the access point 12 of the information as a control signal.

The control signal transmitting/receiving unit CTR3 of the controller 13 receives control signals from each of the terminals 11 and the access point 12 and organizes the amount of stored packets, the information about the terminal 11, the access point 12, and the flow-based buffers (FB1 and FB2) included in the control signals into a database DB.

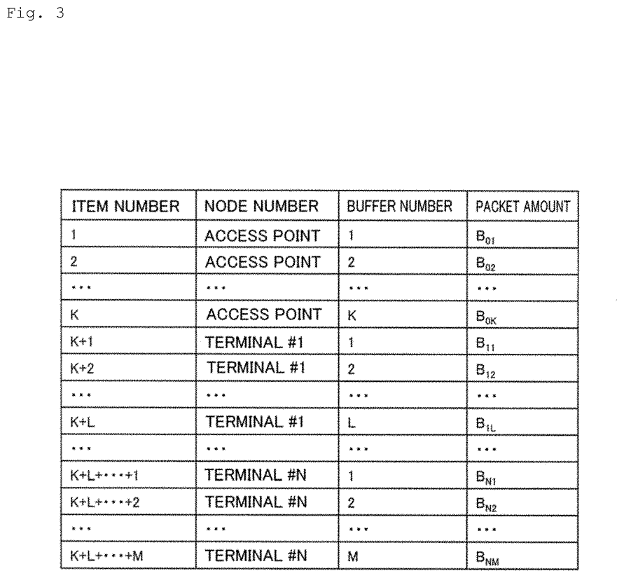

FIG. 3 illustrates an example of the information organized in the database DB. The database DB organizes the following three types of information.

The item number is a serial number assigned to all buffers (FB1 and FB2) of the terminal 11 and the access point 12.

The node number is the number of the access point 12 or terminal 11.

The buffer number is a number assigned to the buffer FB1 of each of the terminals 11 or a number assigned to the buffer FB2 of the access point 12.

The amount of packets is the amount of packets stored in a buffer having a buffer number.

For example, the item number K+2 refers to the packet storage amount of the flow-based buffer unit FB1 #2 of the terminal 11 #1, indicating that the amount is “B12”.

The scheduling unit SCH3 of the controller 13 determines the transmission time and amount for each buffer from the content of the database unit DB using the scheduling method which will be described. The scheduling unit SCH3 then uses the determined transmission time and amount as a control signal and transmits the signal from the control signal transmitting/receiving unit CTR3 to the terminal 11 and the access point 12.

Each of the terminals 11 and the access point 12 take out packets stored in the flow-based buffer units (FB1 and FB2) according to the notified transmission time and amount and input the packets to the main signal buffer units (MB1 and MB2). The main signal transmitting/receiving units (MTR1 and MTR2) transmit the packets in the main signal buffer units (MB1 and MB2) to the wireless network 15.

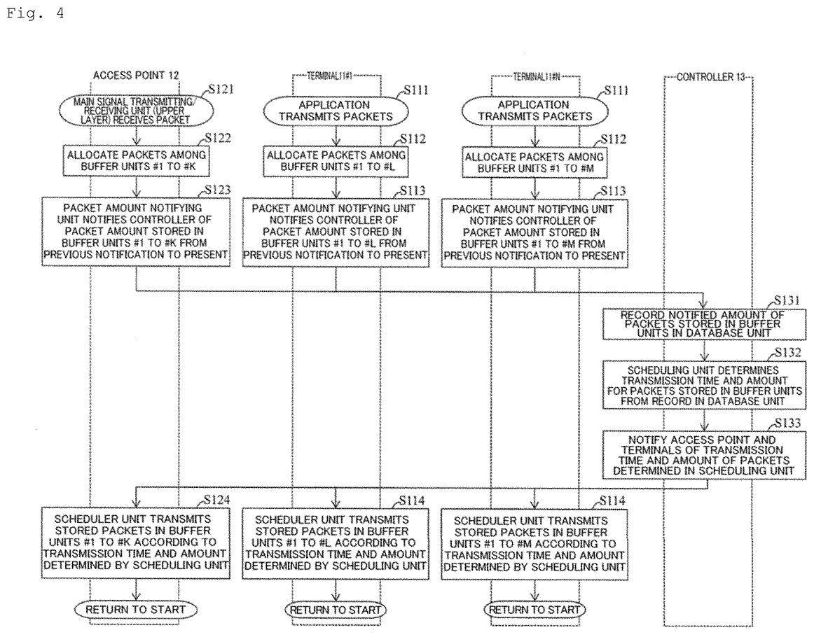

FIG. 4 is a flowchart for illustrating the operation described above. The control method according to the embodiment is a control method for controlling traffic in the wireless network 15.

The control method is transmission control performed by the controller 13 for terminals 11 and the access point 12 that transmit packets to each other over the wireless network 15, and the method includes storing transmission packets in the buffers (FB1 and FB2) of the terminals 11 and the access point 12 on a traffic flow basis (steps S111, S112, S121, and S122), transmitting to the controller the amount of stored transmission packets on a traffic flow basis stored in the buffers (steps S113 and S123), determining, using the controller, transmission time and a transmission amount of the transmission packets on a traffic flow basis according to the stored amount received from the terminals and the access point (steps S131 and S132), and transmitting the transmission time and the transmission amount from the controller to each of the terminals and the access point (step S133), and transmitting the transmission packets on a traffic flow basis from the buffers of the terminals and the access point to the wireless network according to the transmission time and the transmission amount (steps S114 and S124).

[Effects]

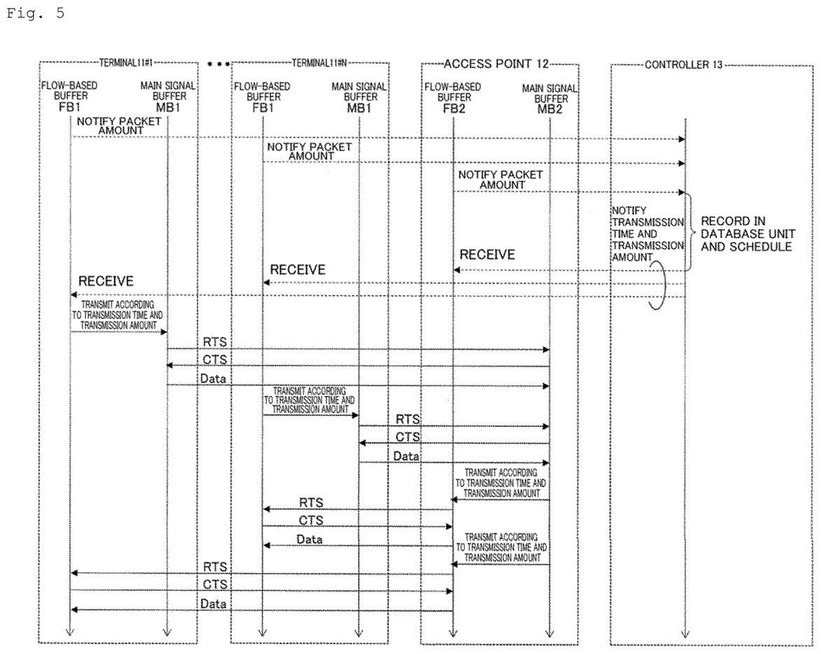

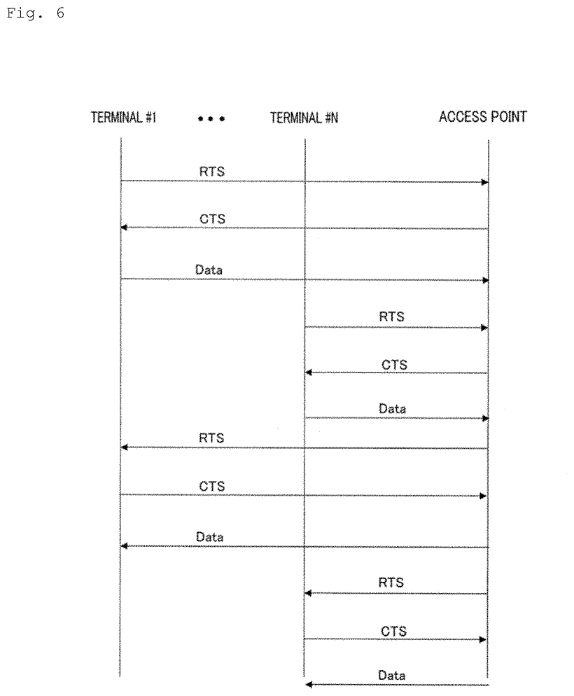

FIGS. 5 and 6 illustrate the effect of the control system 301. FIG. 5 is a sequence diagram of the control system 301, and FIG. 6 is a sequence diagram of a conventional communication system without the controller 13. In these figures, “RTS” means Request To Send, and “CTS” means Clear to Send. The solid line indicates main signal communication, and the broken line indicates control signal communication.

As can be understood from comparison between FIGS. 5 and 6, the communication operation from the main signal buffers (MB1 and MB2) in FIG. 5 is the same as the communication operation in FIG. 6. The control system 301 according to the invention can be implemented by providing the controller 13 without altering an existing communication system. Since no transmission time control is carried out in the communication operation in FIG. 6, troubles such as packet collisions and non-uniformity about terminals or access points allowed to transmit, while the control system 301 according to the invention controls transmission time with respect to terminals and access points, and therefore the troubles are not encountered.

[Scheduling Method]

Here, a scheduling method carried out by a scheduling unit SCH13 of the controller 13 will be described.

[1] Fair Scheduling

According to the scheduling method, the band or time is divided by the total number of flow-based buffers which stores packets among the flow-based buffers (FB1 and FB2) of the terminal 11 and the access point 12.

The parameters will be described.

The number of flow-based buffers of the terminals 11 and the access point 12 which store packets: n

One cycle time: T [sec]

The main signal total transmission limit amount per cycle time: Z [Bytes/sec]

Time to start transmitting a stored packet: tₛₜₐᵣₜ [sec]

In this case, the transmission amount S_{J} [Bytes] of a flow-based buffer #J is expressed as follows:

$$\begin{matrix}[ Math . 1 ] & \\ {S}_{J} = \frac{Z}{n} & ( 1 )\end{matrix}$$

The transmission time T_{J} [sec] of the flow-based buffer #J is expressed as follows:

$$\begin{matrix}[ Math . 2 ] & \\ {T}_{J} = \frac{T}{n} & ( 2 )\end{matrix}$$

The transmission time t_{J} [sec] of the flow-based buffer #J is expressed as follows:

$$\begin{matrix}[ Math . 3 ] & \\ {t}_{J} = {t}_{start} + {\sum }_{J = 1} {T}_{J - 1} & ( 3 )\end{matrix}$$

Note that the sequence of the flow-based buffers which start transmission may be in ascending order based on item numbers organized in the database unit DB of the controller 13, for example.

[2] Scheduling in Consideration of Band Weighting

The scheduling method is based on the number of flow-based buffers in which packets are stored and the amount of stored packets therein among the flow-bass buffers (FB1 and FB2) of the terminal 11 and the access point 12.

The parameters will be described.

The amount of packets stored in the flow-based buffer #J: B_{J} [Bytes]

One cycle time: T [sec]

The transmission limit amount per cycle time: Z [Bytes/sec]

Time necessary for transmitting all the packets stored at all the flow-based buffers: Tₐₗₗ [sec]

Time to transmit the first packet among the packets stored in all the flow-based buffers: tₛₜₐᵣₜ [sec]

In this case, when the following expression holds and Tₐₗₗ≤T,

$$\begin{matrix}[ Math . 4 ] & \\ {T}_{all} = \frac{{\sum }_{J = 1} {B}_{J}}{Z} & ( 4 )\end{matrix}$$

the transmission amount Sⱼ [Bytes] of the flow-based buffer #J is expressed as follows:

$$\begin{matrix}[ Math . 5 a ] & \\ {S}_{J} = {B}_{J} & ( 5 a )\end{matrix}$$

When Tₐₗₗ>T, the following expression results:

$$\begin{matrix}[ Math . 5 b ] & \\ {S}_{J} = \frac{T}{{T}_{all}} {B}_{J} & ( 5 b )\end{matrix}$$

When Tₐₗₗ≤T, the transmission time T_{J} [sec] of the flow-based buffer #J is expressed as follows:

$$\begin{matrix}[ Math . 6 a ] & \\ {T}_{J} = \frac{{S}_{J}}{{\sum }_{J = 1} {B}_{J}} {T}_{all} & ( 6 a )\end{matrix}$$

When Tₐₗₗ>T, the following expression results:

$$\begin{matrix}[ Math . 6 b ] & \\ {T}_{J} = \frac{{S}_{J}}{{\sum }_{J = 1} {B}_{J}} {T}_{all} & ( 6 b )\end{matrix}$$

When Tₐₗₗ≤T, the transmission time t_{J} [sec] of the flow-based buffer #J is expressed as follows:

$$\begin{matrix}[ Math . 7 a ] & \\ {t}_{J} = {t}_{start} + {\sum }_{J = 1} {T}_{J - 1} & ( 7 a )\end{matrix}$$

When Tₐₗₗ>T, the following expression results:

$$\begin{matrix}[ Math . 7 b ] & \\ {t}_{J} = {t}_{start} + {\sum }_{J = 1} {T}_{J - 1} & ( 7 b )\end{matrix}$$

Note that when Tₐₗₗ>T, packets yet to be transmitted remain unsent until next transmission timing.

### Third Embodiment

The second band control approach according to the third embodiment will be described.

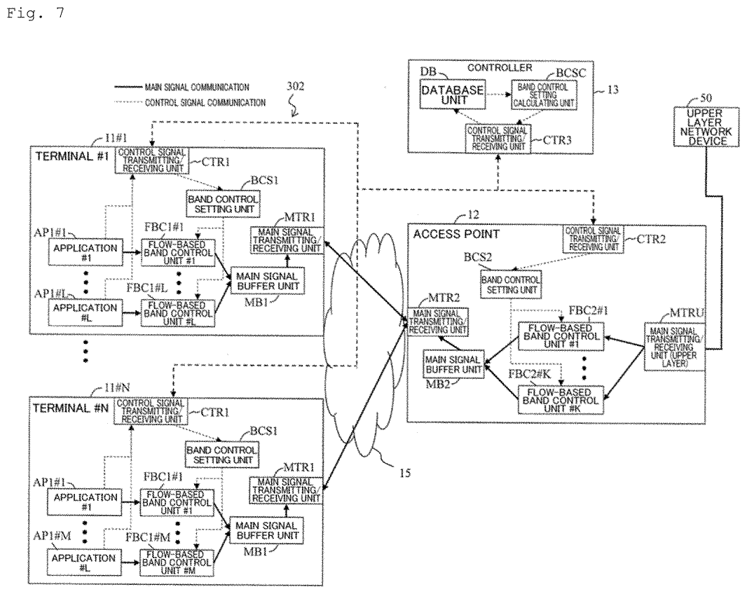

FIG. 7 is a diagram for illustrating a control system 302 according to the embodiment. The control system 302 connects each of the terminals 11 and the access point 12 to the controller 13, a band control unit (FBC1 or FBC2) is provided for each of the terminals or a band control unit in an application on a traffic flow basis in each of the terminals 11 and the access point 12, a band required by the terminal 11 is notified to the controller 13 in advance, the band control setting calculating unit BCSC of the controller 13 determines the band control value of each of the traffic flows for each of the access point 12 and the terminals 11, the band control value is notified to each of the terminals 11 and the access point 12, and packets for each traffic are transmitted within the range of the band control value notified to each of the terminals 11 and the access point 12.

The terminals 11, the access point 12, and the controller 13 are synchronized in time for example using NTP or PTP.

The band control may be based on polishing, shaping, or the like.

According to the first band control approach, transmission is controlled on a packet basis, while according to the second band control approach, the band control value is unchanged unless the required band is changed for example due to addition of an application.

Specifically, the control system 302 controls traffic over the wireless network 15 and has the following feature.

The terminal 11 includes a terminal-side transmitting/receiving unit CTR1 which transmits, as the required band, a band requested by an additional application AP1 to the controller 13 when the terminal is connected to the controller 13 and the application AP1 is added and receives a band control value from the controller 13 and terminal-side band control units (BCS1 and FBC1) which set the band control values for the applications AP1.

The access point 12 includes an access point-side transmitting/receiving unit CTR2 which receives the band control value from the controller 13 and access point-side band control units (BCS2 and FBC2) which set the band control values for the above-described applications.

The controller 13 includes a control side transmitting/receiving unit CTR3 which receives the required band from the terminal 11 and transmits the band control value to the terminal 11 and the access point 12, and a calculating unit BCSC which determines the band control value on the basis of the sum total of the required bands.

According to the embodiment, it is assumed as a precondition that all the terminals 11 and the access points 12 are under the control of the controller 13.

The control system 302 communicates control signals between the controller 13 and the access point 12/the terminal 11 by communication means other than the communication means for main signals (packets in traffic). Specifically, control signals are transmitted and received between the control signal transmitting/receiving unit CTR1 of the terminal 11 and the control signal transmitting/receiving unit CTR3 of the controller 13 and between the control signal transmitting/receiving unit CTR2 of the access point 12 and the control signal transmitting/receiving unit CTR3 of the controller 13.

When the controller 13 and each of the terminals 11 are connected, or when a terminal 11 and an application AP1 are added, the application AP1 of each of the terminals 11 notifies the controller 13 of a required band for uplink and downlink main signal communication.

The controller 13 records the notified required band in the database unit DB, sums up the required bands for the applications AP1, and checks whether the result is within the communication band (main signal band) of the wireless network 15.

When the total of the required bands is within the main signal band, the total value of the required bands is notified as a flow-based band control value to the band control setting unit BCS1 of each of the terminals 11 and the band control setting unit BCS2 of the access point 12.

Meanwhile, when the total of the required bands is not within the main signal band, the required band is reduced so that the total of the required bands is within the main signal band as will be described, and the result is notified to the band control setting unit BCS1 of each of the terminals 11 and the band control setting unit BCS2 of the access point 12 as the flow-based band control value.

The band control setting units (BCS1 and BCS2) set the band control value notified by the controller 13 to the flow-based band control units (FBC1 and FBC2) under their control. Each of the flow-based band control units FBC1 inputs packets from the application AP1 to the main signal buffer unit MB1 according to the set band control value. Meanwhile, each of the flow-based band control units FBC2 inputs packets from the main signal transmitting/receiving unit (upper layer) MTRU to the main signal buffer unit MB2 according to the set band control value. The main signal transmitting/receiving units (MTR1 and MTR2) transmit the packets from the main signal buffer units (MB1 and MB2) to the wireless network 15.

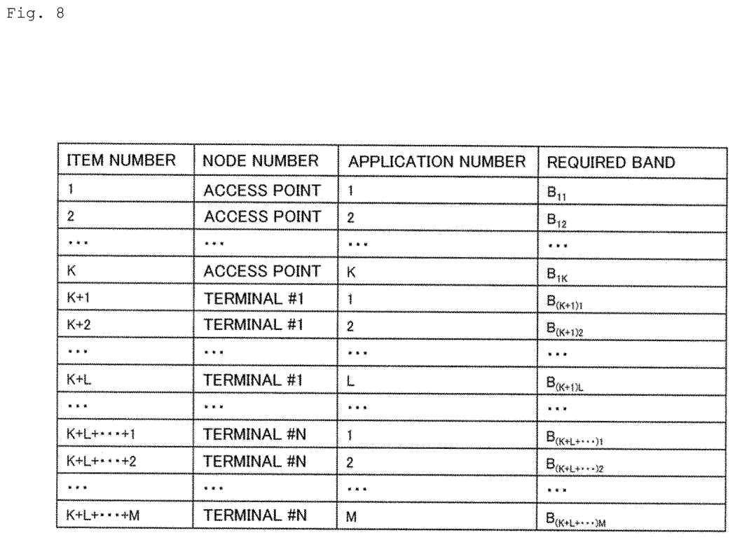

FIG. 8 illustrates an example of the information organized in the database DB. The following three kinds of information are organized in the database DB.

The item number is a serial number for each of all the traffic flows for the terminals 11 and the access point 12.

The node number is a number assigned to the access point 12 or the terminal 11.

The traffic flow number is a number assigned to an application AP1 owned by each terminal 11 or a number assigned to a traffic flow through the access point 12.

The required band is a band required by each traffic flow (application).

For example, the item number K+2 refers to a band required by the traffic flow of application AP1 #2 of the terminal 11 #1, which means that the amount is “B_{(K-1)2}”.

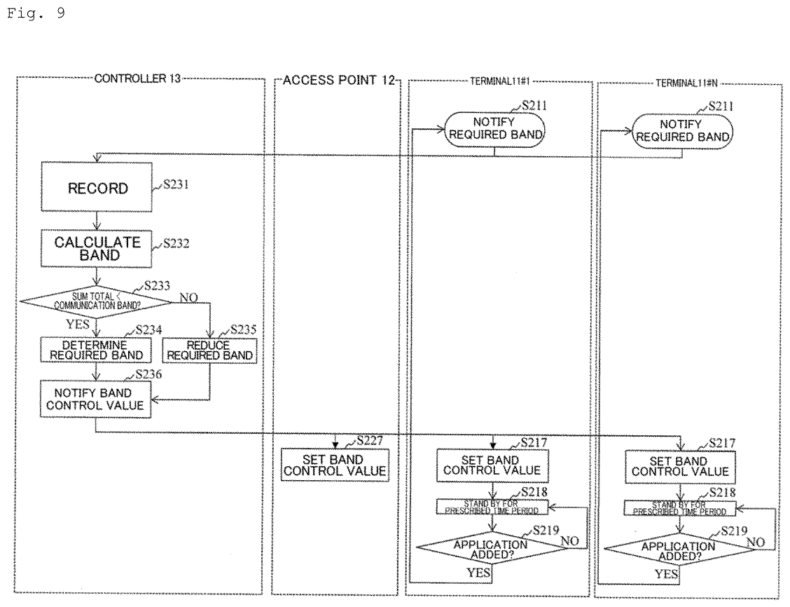

FIG. 9 is a flowchart for illustrating the above-described operation. The control method according to the embodiment controls traffic over the wireless network 15.

According to the control method, transmission control is performed by the controller 13 for the terminals 11 and the access point 12 which transmit packets to each other over the wireless network 15.

When each of the terminals 11 is connected to the controller 13 or when an application AP1 is added, the node number, the application number (traffic flow number), and the required band for each application are notified to the controller 13 (step S211).

The controller 13 records the node number, the application number (traffic flow number), and the required band for uplink and downlink communication for each flow received from each of the terminals 11 in the database unit DB (step S231).

The band control setting calculating unit BCSC of the controller 13 calculates the sum total of the required bands in the main signal section (the network 15) on the basis of the information in the database unit DB (step S232).

The band control setting calculating unit BCSC of the controller 13 compares the calculated sum total with the communication band of the network 15 (step S233).

When the sum total≤the communication band (“Yes” in step S233), the band control setting calculating unit BCSC determines the required band for each flow as the band control value (step S234).

When the sum total the communication band (“No” in step S233), then the band control setting calculating unit BCSC reduces the required band for each flow so that the sum total is within the communication band and determines the reduced required band as the band control value (step S235).

The control signal transmitting/receiving unit CTR3 notifies the access point 12 and each of the terminals 11 of the band control value determined by the band control setting calculating unit BCSC (step S236).

The band control setting unit BCS2 of the access point 12 sets a band control value for each flow notified by the controller 13 in the flow-based band control unit FBC2 (step S227).

The band control setting unit BCS1 of the terminal 11 sets a band control value for each flow notified by the controller 13 to the flow-based band control unit FBC1 (step S217).

The terminal 11 forwards packets with the set band control value for a prescribed period of time (step S218) and checks whether a new application AP1 has been added (step S219).

When a new application AP1 has been added (“Yes” in step S219), this control method repeats the operation from step S211. Meanwhile, when no new application AP1 has been added (“No” in step S219), the terminal 11 again stands by for a prescribed period of time in step S218.

[Effects]

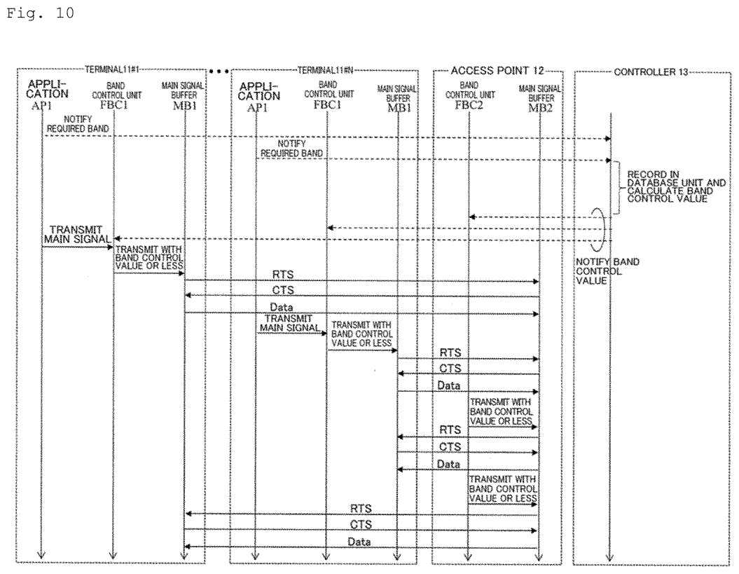

FIGS. 10 and 5 illustrate an effect provided by the control system 302. FIG. 10 is a sequence diagram of the control system 302, and FIG. 5 is a sequence diagram of a conventional communication system without the controller 13. In the figures, “RTS” refers to Request To Send and “CTS” refers to Clear to Send. The solid line indicates main signal communication, and the broken line indicates control signal communication.

As can be seen from comparison between FIGS. 10 and 5, communication operation from the main signal buffers (MB1 and MB2) in FIG. 10 is the same as communication operation in FIG. 5. The control system 302 according to the present invention can be implemented by providing the controller 13 without altering an existing communication system. In the communication operation in FIG. 5, it is difficult to allocate a band on a detailed traffic flow basis such as services and applications because transmission control is performed on a terminal basis, while the control system 302 according to the present invention operates according to the traffic flow-based band control value notified by the controller, a band allocated on a traffic flow basis can be guaranteed.

[Band Control Value Calculation Formula]

Now, a band control value calculation formula used by the band control setting calculating unit BCSC of the controller 13 will be described.

The parameters are as follows.

Total number of flows between the terminal 11 and the access point 12: n

Main signal band: Z [Bytes/sec]

Total of required bands for all the flows (sum total): Rₐₗₗ [Bytes/sec]

Required band for flow #J: Rⱼ [Bytes/sec]

Band control setting value for flow #J: B_{J} [Bytes/sec].

In this case, the following expression holds,

$$\begin{matrix}[ Math . 8 ] & \\ {R}_{all} = {\sum }_{n} {R}_{j} & ( 8 )\end{matrix}$$

and when Rₐₗₗ≤Z, the band control setting value for each flow is each within the required band and as for the flow #J, the following expression results.

BJ=Rⱼ [Math. 9]

Meanwhile, when Rₐₗₗ>Z, the band control setting value for each flow must be set smaller than each required band. As for the flow #J, the following expression results.

$$\begin{matrix}[ Math . 10 ] & \\ {B}_{J} = \frac{Z}{{R}_{all}} {R}_{J} & ( 10 )\end{matrix}$$

### Fourth Embodiment

The controller 13 can be implemented by a computer and a program, and the program can be recorded on a recording medium or provided over a network.

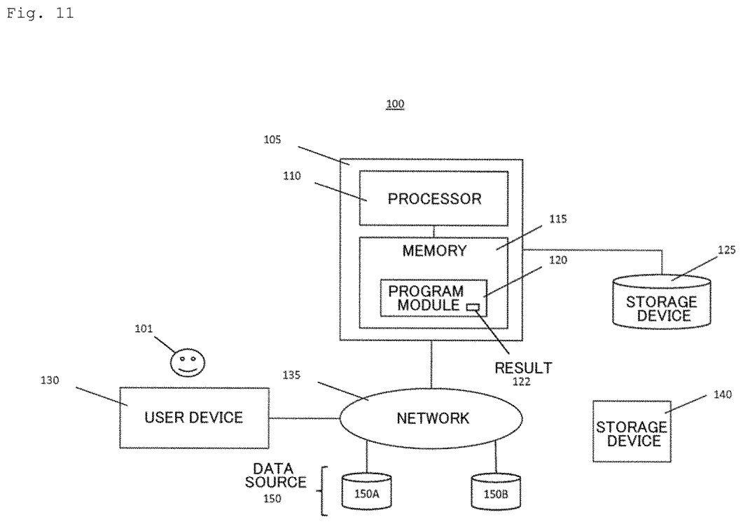

FIG. 11 is a block diagram of a system 100. The system 100 includes a computer 105 connected to a network 135.

The network 135 is a data communication network. The network 135 may be a private network or a public network and may include any one or all of (a) a personal area network which covers for example a certain room, (b) a local area network which covers for example a certain building, (c) a campus area network which covers for example a certain campus, (d) a metropolitan area network which covers a certain urban city, (e) a wide area network which covers a region connected across the boundaries of urban cities, rural areas, or nations, and (f) the Internet. The communication is carried out by electronic signals or optical signals over the network 135.

The computer 105 includes a processor 110 and a memory 115 connected to the processor 110. Although illustrated as a standalone device herein, the computer 105 is not limited as such but rather may be connected to other devices which are not shown in a distributed processing system.

The processor 110 is an electronic device including a logic circuit which responds to and executes instructions.

The memory 115 is a tangible, computer-readable storage medium on which a computer program is encoded. In this regard, the memory 115 stores data and instructions or a program code which can be read and executed by the processor 110 to control the operation of the processor 110. The memory 115 can be implemented by a random access memory (RAM), a hard drive, or a read-only memory (ROM), or a combination thereof. One of the elements of the memory 115 is a program module 120.

The program module 120 includes instructions for controlling the processor 110 to perform the processes described herein. Although the operations described herein are performed by the computer 105 or a method or a process or a sub-process thereof, those kinds of operation are actually carried out by the processor 110.

The term “module” is used herein to refer to functional operation which may be embodied as either a stand-alone element or an integrated configuration comprising a plurality of subordinate elements. Therefore, the program module 120 can be implemented as a single module or as a plurality of modules which operate in cooperation with one another. Although the program module 120 described herein is installed in the memory 115 and thus implemented by software, the module can be implemented by hardware (such as an electronic circuit), firmware, or software, or any combination thereof.

The program module 120 is shown as having been already loaded in the memory 115, but may be configured to be located on the storage device 140 for later loading into the memory 115. The storage device 140 is a tangible, computer-readable storage medium that stores the program module 120. Examples of the storage devices 140 include a compact disk, a magnetic tape, a read-only memory, an optical storage medium, a memory unit comprising a hard drive or multiple parallel hard drives, and a Universal Serial Bus (USB) flash drive. Alternatively, the storage device 140 may be a random access memory, or any other type of electronic storage device located in a remote storage system (not shown) and connected to the computer 105 over the network 135.

The system 100 further includes a data source 150A and a data source 150B collectively referred to as data sources 150 herein and connected to the network 135 so that communication is allowed therebetween. In practice, the data source 150 may include any number of data sources, in other words, one or more data sources. The data source 150 can include unsystematized data and can include social media.

The system 100 further includes a user device 130 which is operated by the user 101 and connected to the computer 105 over the network 135. The user device 130 can be an input device such as a keyboard and a voice recognition subsystem to enable the user 101 to communicate information and command selection to the processor 110. The user device 130 further includes an output device such as a display device, a printer and a speech synthesizer. A cursor control unit such as a mouse device, a trackball, and a touch-sensitive screen allows the user 101 to manipulate the cursor on the display device to communicate further information and command selection to the processor 110.

The processor 110 outputs the result 122 of execution of the program module 120 to the user device 130. Alternatively, the processor 110 can communicate the output for example to a storage device 125 such as a database and a memory or to a remote device (not shown) over the network 135.

For example, the program which performs steps S131 to S133 in the flowchart in FIG. 4 or steps S231 to S236 in FIG. 9 may be the program module 120. The system 100 can be operated as the controller 13.

The term “having . . . ” or “including . . . ” specifies the presence of a feature, an integer, a process, or an element described therein, but the same should not be construed as excluding the presence of one or more other features, integers, processes, or elements, or a group thereof. The terms “a” and “an” are indefinite articles, and therefore the possibility of an embodiment having more than one element represented by a term preceded by one of the indefinite articles is not excluded.

### OTHER EMBODIMENTS

The invention is not limited by the above embodiments but can be implemented with various modifications without departing from the gist and scope of the invention. In short, the invention is not limited by the above embodiments as they are but can be embodied by modifying the elements without departing from the gist and airbag device scope thereof.

Various features can be made by combining any of the plurality of elements disclosed in the above description of the embodiments as appropriate. For example, some elements may be omitted from all the elements in the embodiments. Elements among different embodiments may be combined as appropriate.

### REFERENCE SIGNS LIST

11 Terminal
12 Access point
13 Controller
15 Wireless network
50 Upper layer network device
100 System
101 User
105 Computer
110 Processor
115 Memory
120 Program module
122 Result
125 Storage device
130 User device
135 Network
140 Storage device
150 Data source
300, 301, 302 Control system

1. A control system for controlling traffic over a wireless network, the system comprising:
a terminal and an access point which transmit a packet to each other over the wireless network; and
a controller which carries out transmission control to the terminal and the access point,
the controller determining a band control value for each traffic flow according to a required band for the traffic flow notified at least from the terminal and notifying the terminal and the access point of the band control value.

2. The control system according to claim 1, wherein
the terminal and the access point each comprise:
a buffer which stores transmission packets on a traffic flow basis;
a device side transmitting/receiving unit which transmits the amount of stored transmission packets on a traffic flow basis stored in the buffer and receives transmission time and a transmission amount of the transmission packets on a traffic flow basis from the controller as the band control value; and
a main signal transmitting unit which transmits the transmission packets on a traffic flow basis in the buffer to the wireless network according to the transmission time and the transmission amount, and
the controller comprises:
a control side transmitting/receiving unit which receives the stored amount each from the terminal and the access point as the required band and transmits the transmission time and the transmission amount to each of the terminal and the access point as the band control value; and
a scheduling unit which determines the transmission time and the transmission amount of the transmission packets on a traffic flow basis according to the stored amount.

3. The control system according to claim 1, wherein
the terminal comprises:
a terminal side transmitting/receiving unit which transmits a band requested by an application to the controller as the required band and receives the band control value from the controller when the terminal is connected to the controller and the application is added; and
a terminal side band control unit which sets the band control unit for each of the applications,
the access point comprises:
an access point side transmitting/receiving unit which receives the band control value from the controller; and
an access point side band control unit which sets the band control value for each of the applications, and
the controller comprises:
a control side transmitting/receiving unit which receives the required band from the terminal and transmits the band control value to each of the terminal and the access point; and
a calculating unit which determines the band control value according to the sum total of the required bands.

4. The control system according to claim 3, wherein
the calculating unit sets the required band for each of the traffic flows as the band control value when the sum total is less than the communication band of the wireless network, and the calculating unit sets, as the band control value, a value obtained by reducing the required band for each of the traffic flows so that the sum total is at most equal to the communication band when the sum total is at least equal to the communication band of the wireless network.

5. A control method for controlling traffic over a wireless network, the control method being transmission control carried out by a controller to a terminal and an access point which transmit a packet to each other over the wireless network,
the method comprising:
determining a band control value for each traffic flow according to a required band for the traffic flow notified at least from the terminal; and
notifying the terminal and the access point of the band control value.

6. A controller for controlling traffic over a wireless network,
the controller being a device which carries out transmission control to a terminal and an access point which transmit a packet to each other over the wireless network, the controller having the function of determining a band control value for each of traffic flows according to a required band for the traffic flow notified at least from the terminal, and notifying the terminal and the access point of the band control value.

7. A non-transitory computer-readable medium having computer-executable instructions that, upon execution of the instructions by a processor of a computer, cause the computer to function as the controller according to claim 6.
